(19) United States
(12) Patent Application Publication
(10) Pub. No.: US 2023/0327746 A1
(43) Pub. Date: Oct. 12, 2023

(54) WIRELESS COMMUNICATION METHOD AND WIRELESS COMMUNICATION APPARATUS

(71) Applicant: NIPPON TELEGRAPH AND TELEPHONE CORPORATION, Tokyo (JP)

(72) Inventors: Shuki WAI, Musashino-shi, Tokyo (JP); Tatsuhiko IWAKUNI, Musashino-shi, Tokyo (JP); Daisei UCHIDA, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 18/022,267

(22) PCT Filed: Aug. 25, 2020
(86) PCT No.: PCT/JP2020/031954

§ 371 Date: Feb. 20, 2023

(51) Int. Cl. H04B 7/155; H04B 7/08; H04B 7/06; H04B 17/318

(52) U.S. Cl. CPC H04B 7/155; H04B 17/318; H04B 7/0695; H04B 7/088

(57) ABSTRACT

A wireless communication method includes a reception step of receiving a signal transmitted from a first wireless station, a transmission step of transmitting the signal received in the reception step to a second wireless station, a control signal transmission/reception step of transmitting/receiving a control signal related to switching of a reception beam used in the reception step or a transmission beam used in the transmission step, and a beam control step of controlling switching of the reception beam or the transmission beam on the basis of the control signal.

### TECHNICAL FIELD

The present invention relates to a wireless communication method and a wireless communication device.

### BACKGROUND ART

In wireless communication, a communication range in which a signal can be received with desired power is limited by distance attenuation in which signal power is attenuated according to a propagation distance. In the wireless communication using a high frequency band such as a millimeter wave band, radio waves cannot be delivered to a position where there is no prospect because of a strong straight advance property of a signal. Therefore, in the wireless communication system, a wireless relay device capable of amplifying a wireless signal or changing a traveling direction of the wireless signal may be used (NPL 1).

There are several methods for relaying wireless signals by the wireless relay device. For example, the relay method includes the relay method for amplifying the wireless signal and the relay method for not amplifying the wireless signal.

The relay method for amplifying the wireless signal includes a reproduction wireless relay and a non-reproduction wireless relay. The reproduction wireless relay is the relay method in which the wireless signal received from a wireless station is once demodulated, error correction is performed, amplified, modulated again, and transmitted to another wireless station. On the other hand, non-reproduction wireless relay is a relay method in which the wireless signal received from the wireless station is not demodulated and modulated, but only amplification is performed and transmitted to another wireless station (for example, PTL 1).

As the relay method for not amplifying the wireless signal, there are a relay method for forcibly changing the propagation direction of the radio wave by a reflector such as a metal plate, and a relay method for changing the propagation direction of the radio wave by electrically controlling the reflection direction by using a metamaterial or a MEMS (Micro Electro Mechanical Systems), for example (for example, refer to NPL 2).

Reproduction wireless relay has a drawback that processing delay occurs because demodulation, modulation and error correction of wireless signals are performed. Since the reproduction wireless relay requires a digital processing circuit for demodulating, modulating, and correcting errors of wireless signals, there is a drawback that a device becomes large and a device cost increases.

On the other hand, since the relay method which does not perform non-reproduction wireless relay and amplification of the wireless signal does not perform demodulation, modulation, and error correction of the wireless signals, there is an advantage that no processing delay occurs. In addition, since the relay method which does not perform the non-reproduction wireless relay and amplification of wireless signals does not require the digital processing circuit and can reduce the number of circuits, the device can be miniaturized and the device cost can be reduced.

There is a slight difference in configuration, such as a difference in whether or not an amplifier circuit is provided between the above-mentioned non-reproduction wireless relay and the relay method not amplifying the wireless signals. However, these two relay methods are common in that the digital processing circuit is not required. In the following description, non-reproduction wireless relay and a relay method not amplifying wireless signals are generally referred to as “non-reproduction wireless relay or the like”.

The wireless communication using the high frequency band such as the millimeter wave band has a feature that the free space propagation loss is larger than that of the wireless communication using a low frequency band such as a microwave band. For this reason, in the wireless communication using the high frequency band such as the millimeter wave band, beam forming is used to compensate for the free space propagation loss (for example, refer to NPL 3). The beam forming is a technique for improving directivity of radio waves by forming a beam in which power is concentrated in a specific direction.

In the case of P-P (Point-to-Point) type wireless communication in which the combination of wireless stations to be communicated is always the same, and in the case where the mutual positional relation between the wireless stations to be communicated and the radio wave propagation environment around the wireless stations is not changed, the beam forming direction in the beam forming can be set to a fixed direction. In this case, the fixed beam forming direction is set in advance, for example, at the time when the wireless station is installed.

On the other hand, in the case of P-MP (Point-to-Multi Point) type wireless communication accommodating a plurality of wireless stations, or in the case where at least one of the wireless stations to be communicated with each other moves, the beam forming direction in the beam forming cannot be set to the fixed direction. Therefore, in this case, it is necessary to use adaptive beam forming. The adaptive beam forming is a technique for adaptively controlling the beam forming direction in the beam forming in accordance with a change in a wireless station to be communicated, a change in a mutual positional relationship with the wireless station to be a communicated due to movement of the wireless station, a change in a radio wave propagation environment around the wireless station. In general, the adaptive beamforming is realized by adjusting the phase relationship of radio waves to be radiated among a plurality of antenna elements without requiring a mechanical drive unit.

In order to appropriately adjust the phase relationship of the radio waves to be radiated, it is necessary to derive the phase relationship of the radio waves between the antenna elements of the wireless station on the transmitting side and the wireless station on the receiving side in advance. That is, it is necessary to grasp the state of the propagation path for all combinations of the antenna elements of the wireless station on the transmitting side and the antenna elements of the wireless station on the receiving side. This can be realized by transmitting and receiving known signals between the wireless station on the transmitted side and the wireless station on the receiving side. However, in this case, the wireless station cannot transmit and receive other signals while the known signals are being transmitted and received. Further, in order to accurately transmit the state of the propagation path, the overhead of communication increases.

On the other hand, in the adaptive beam forming, an increase in overhead can be suppressed by discrete beam selection. In the discrete beam selection, a beam ID is associated with each of a plurality of discretely set candidate beams, and a signal including the beam ID is transmitted and received by each candidate beam. The discrete beam selection is a technique for specifying a beam ID associated with a candidate beam most suitable for communication on the basis of a result of transmission and reception of each candidate beam, and selecting a beam to be used for the beam forming. In recent years, the discrete beam selection has been advanced in practical use, and is implemented in the wireless communication system defined in 3 GPP 5G (5th Generation), IEEE 802.11adI, etc. (for example, refer to NPL 3, 4 and 5).

An example of a conventional wireless system for selecting the discrete beams will be described below.

FIG. 18 is a schematic diagram of the wireless system for selecting the discrete beam. As shown in FIG. 18, for example, a wireless station 91 on the transmitting side selects an optimum forming direction from among transmission beams b1 in a plurality of discretely set forming directions, and a wireless station 92 on the receiving side selects the optimum forming direction from the reception beams b2 in a plurality of discretely set forming directions. The wireless stations 91 and 92 may be wireless stations for transmitting and receiving signals to and from each other.

FIG. 19 is a block diagram illustrating an example of a configuration of the wireless station 91 on the transmitting side for performing the discrete beam. In the case of selecting the discrete beam of the transmission beam b1, the wireless station 91 on the transmitting side needs to be provided with the digital processing circuit as shown in FIG. 19. Further, the digital processing circuit needs to have a beam search signal generation unit as shown in FIG. 19. The beam search signal generation unit generates beam search signals in which a beam ID capable of uniquely specifying each candidate beam on the transmitting side is embedded as digital information. The wireless station 91 on the transmitting side places each beam search signal generated by the beam search signal generation unit on each candidate beam generated by switching in time, and transmits the beam search signal to the wireless station 92 on the receiving side.

The wireless station 92 on the receiving side measures the reception power of each candidate beam. The wireless station 92 on the receiving side reads the beam ID embedded in the beam search signal. The wireless station 92 on the receiving side determines the candidate beam having the best reception quality on the basis of the reception power. The wireless station 92 on the receiving side feeds back the information indicating the determination result (that is, the beam ID embedded in the specified candidate beam, or the like) to the wireless station 91 on the transmission side. Generally, the beam ID is also fed back using the digital information. Therefore, as shown in FIG. 19, the digital processing circuit of the wireless station 91 on the transmitting side needs to further include a data processing unit for processing the fed-back information and a beam ID read unit.

In the case of a wireless communication system such as a TDD (Time Division Duplex) system using the same frequency in transmission and reception, the same beam as the transmission beam can be selected as the reception beam. On the other hand, in the case of a wireless communication system such as an FDD (Frequency Division Duplex) system using different frequencies in transmission and reception, it is necessary to select the discrete beam of the reception beam by using the beam search signal (the reception beam search signal) in the same manner as the above-mentioned discrete beam selection of the transmission beam.

The reception beam search signal used for the discrete beam selection of the reception beam is generated by the wireless station to be communicated. Therefore, it is necessary for the wireless station to transmit a transmission request signal for requesting transmission of the reception beam search signal to the wireless station to be communicated. In general, the transmission request signal is also transmitted using the digital information. Therefore, as shown in FIG. 19, the digital processing circuit of the wireless station 91 on the transmitting side needs to further include a control signal generation unit for generating the transmission request signal.

Thus, in the discrete beam selection, it is essential that the wireless station has the digital processing circuit capable of generating and analyzing the digital information. Therefore, in the relay device (referred to as “non-reproduction wireless relay device”) which does not have the digital processing circuit capable of performing the digital processing on the signal to be relayed, it is difficult to perform the beam selection. In general, a situation of utilization of non-reproduction wireless relay or the like has been limited to a case where in the P-P type wireless communication system using, for example, a fixed microwave line or the like, the positional relationship between wireless stations to be communicated with each other and the radio wave propagation environment around the wireless stations do not change, or a case where relaying a non-directional signal is performed (for example, refer to NPL 6).

### CITATION LIST

### Patent Literature

[PTL 1] Japanese Patent Application Publication No. 2006-340274

### Non Patent Literature

[NPL 1] Masashi Iwabuchi, and others, “Proposal of high-frequency band multi-path formation control by a large number and various of relay systems”, IEICE general conference, proceeding 1, B-5-10, p. 389, March 2020.

[NPL 2] Q. Wu et al., “Intelligent Reflecting Surface Enhanced Wireless Networks via Joint Active and Passive Beamforming”, IEEE Transactions on Wireless Communications, Vol. 18, No. 11, pp. 5394 to 5409, November 2019.

[NPL 3] “5G multi-antenna technology” NTT DOCOMO Technical Journal, Vol. 23, No. 4, pp. 30 to 39, January 2016.

[NPL 4] Kazuaki Takeda, and others, “Study status for technology for the physical layer and the high frequency band utilization in 5G”, NTT DOCOMO Technical Journal, Vol. 25, No. 3, PP 23 to 32, October 2017.

[NPL 5] Koji Takinami, and others, “Standardization trend and element technology of the millimeter wave bad wireless LAN system”, IEICE communication society magazine, No. 38, Autumn issue, pp. 100 to 106, 2016.

[NPL 6] Hiroshi Murakami, and others, “Terrestrial digital broadcasting transmission network system”, Toshiba review, Vol. 62, No. 2, pp. 58 to 63, 2007.

### SUMMARY OF INVENTION

### Technical Problem

As described above, the non-reproduction wireless relay device does not include the digital processing circuit for performing the digital processing on the signal to be relayed. Therefore, the conventional non-reproduction wireless relay device cannot transmit and receive the beam search signal, which is the digital signal, for each discrete beam. Therefore, there is a problem for the conventional non-reproduction wireless relay device to not perform the discrete beam selection in the adaptive beam forming.

In view of the above-mentioned circumstances, the present invention aims to provide the wireless communication method and the wireless communication device capable of selecting the discrete beam without providing the digital processing circuit.

### Solution to Problem

A wireless communication method of one aspect of the present invention includes, a reception step of receiving a signal transmitted from a first wireless station, a transmission step of transmitting the signal received in the reception step to a second wireless station, a control signal transmitting/reception step of transmitting/receiving a control signal related to switching of a reception beam used in the reception step or a transmission beam used in the transmission step to/from external equipment, and a beam control step of controlling switching of the reception beam or the transmission beam based on the control signal.

A wireless communication device of one aspect of the present invention includes, a reception unit that receives the signal transmitted from the first wireless station, a transmission unit that transmits the signal received by the reception unit to the second wireless station, a control signal transmitting/receiving unit that transmits/receives the control signal related to the switching between the reception beam used in the reception unit or the transmission beam used in the transmission unit, and a beam control unit that controls the switching of the reception beam or the transmission beam on the basis of the control signal.

### Advantageous Effects of Invention

According to the present invention, the discrete beam selection can be performed without providing the digital processing circuit.

### BRIEF DESCRIPTION OF DRAWINGS

FIG. 1 is an entire configuration diagram of a wireless communication system 1 according to a first embodiment of the present invention.

FIG. 2 is a block diagram illustrating the configuration of a non-reproduction wireless relay device 10 according to the first embodiment of the present invention.

FIG. 3 is a block diagram illustrating a functional configuration of a base station 20 according to the first embodiment of the present invention.

FIG. 4 is a flowchart illustrating an operation of the base station 20 according to the first embodiment of the present invention.

FIG. 5 is a flowchart illustrating the operation of the non-reproduction wireless relay device 10 according to the first embodiment of the present invention.

FIG. 6 is a schematic diagram illustrating a relationship between a beam search signal transmitted by the base station 20 and switching of a transmission beam by the non-reproduction wireless relay device 10 according to the first embodiment of the present invention.

FIG. 7 is a flowchart illustrating the operation of the base station 20 according to the second embodiment of the present invention.

FIG. 8 is a flowchart illustrating the operation of the non-reproduction wireless relay device 10 according to the second embodiment of the present invention.

FIG. 9 is a flowchart illustrating the operation of the base station 20 according to the third embodiment of the present invention.

FIG. 10 is a flowchart illustrating the operation of the non-reproduction wireless relay device 10 according to the third embodiment of the present invention.

FIG. 11 is a flowchart illustrating the operation of the base station 20 according to the fourth embodiment of the present invention.

FIG. 12 is a flowchart illustrating the operation of the non-reproduction wireless relay device 10 according to the fourth embodiment of the present invention.

FIG. 13 is a block diagram illustrating the configuration of a non-reproduction wireless relay device 10a according to the fifth embodiment of the present invention.

FIG. 14 is a flowchart illustrating the operation of the base station 20 according to the fifth embodiment of the present invention.

FIG. 15 is a flowchart illustrating the operation of the non-reproduction wireless relay device 10a according to the fifth embodiment of the present invention.

FIG. 16 is a flowchart illustrating the operation of the base station 20 non-reproduction wireless relay device 10a according to the sixth embodiment of the present invention.

FIG. 17 is a flowchart illustrating the operation of the base station 20 non-reproduction wireless relay device 10a according to the sixth embodiment of the present invention.

FIG. 18 is a schematic diagram of a wireless system performing discrete beam selection.

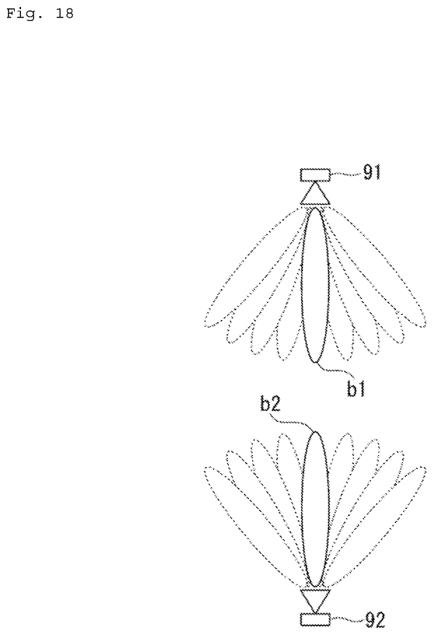

FIG. 19 is a block diagram illustrating an example of the configuration of the wireless station 91 on the transmitting side for performing the discrete beam selection.

### DESCRIPTION OF EMBODIMENTS

Hereinafter, the wireless communication method and the wireless communication device according to the embodiments of the present invention will be described with reference to the drawings.

### First Embodiment

The first embodiment of the present invention will be described below.

### [Entire Configuration of the Wireless Communication System]

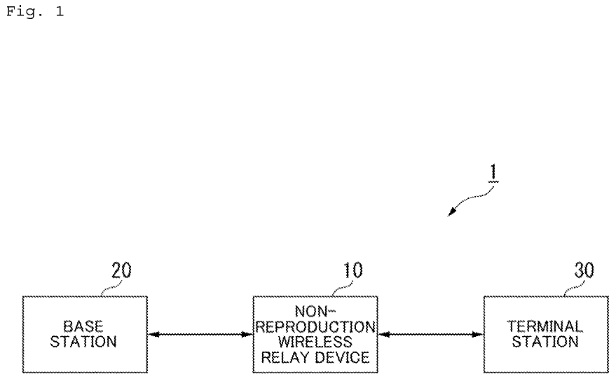

FIG. 1 is an entire configuration diagram of a wireless communication system 1 according to the first embodiment of the present invention. As shown in FIG. 1, the wireless communication system 1 includes a non-reproduction wireless relay device 10, a base station 20, and a terminal station 30. The non-reproduction wireless relay device 10 is the relay device for relaying a signal of wireless communication transmitted and received between the base station 20 and the terminal station 30 by non-reproduction wireless relay or the like.

The non-reproduction wireless relay device 10 receives the signal of the wireless communication transmitted from the base station 20, amplifies the received signal, and transmits the amplified signal to the terminal station 30. The non-reproduction wireless relay device 10 receives the signal of the wireless communication transmitted from the terminal station 30, amplifies the received signal, and transmits the amplified signal to the base station 20. The non-reproduction wireless relay device 10, the base station 20, and the terminal station 30 can transmit and receive the signal of the wireless communication by using the beam forming.

The wireless communication system 1 according to the first embodiment described below is a communication system capable of selecting a discrete beam of a transmission beam to the terminal station 30 side of the non-reproduction wireless relay device 10.

### [Configuration of a Non-Reproduction Wireless Relay Device]

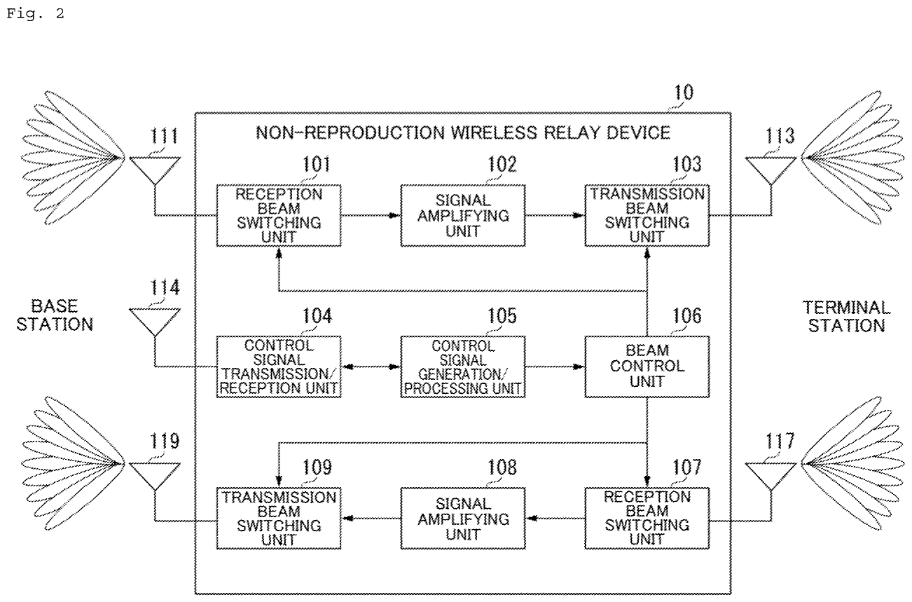

Hereinafter, the functional configuration of the non-reproduction wireless relay device 10 will be described. FIG. 2 is a block diagram illustrating the configuration of the non-reproduction wireless relay device 10 according to the first embodiment of the present invention. As described above, the non-reproduction wireless relay device 10 is a relay device for relaying signals by non-reproduction wireless relay or the like. Therefore, as shown in FIG. 2, the non-reproduction wireless relay device 10 does not include a digital processing circuit for performing the digital processing on the signal to be relayed. The digital processing here includes signal processing such as demodulation, modulation, error correction, and the like, and generation of a beam search signal.

As shown in FIG. 2, the non-reproduction wireless relay device 10 includes a reception beam switching unit 101, a signal amplifying unit 102, a transmission beam switching unit 103, a control signal transmission/reception unit 104, a control signal generation/processing unit 105, a beam control unit 106, a reception beam switching unit 107, a signal amplifying unit 108, a transmission beam switching unit 109, a base station side reception antenna 111, a terminal station side transmission antenna 113, a control signal transmission/reception antenna 114, a terminal station side reception antenna 117, and a base station side transmission antenna 119 for transmitting.

The reception beam switching unit 101 controls the base station side reception antenna 111 to switch a formation direction of the reception beam to the base station 20 side. The base station side reception antenna 111 receives a signal of wireless communication transmitted from the base station 20. The reception beam switching unit 101 acquires the signal received by the base station side reception antenna 111 and outputs the signal to the signal amplifying unit 102.

The signal amplifying unit 102 acquires the signal outputted from the reception beam switching unit 101. The signal amplifying unit 102 electrically amplifies the acquired signal and outputs the amplified signal to the transmission beam switching unit 103.

The transmission beam switching unit 103 controls the terminal station side transmission antenna 113 to switch the formation direction of the transmission beam to the terminal station 30 side. The transmission beam switching unit 103 acquires the amplified signal outputted from the signal amplifying unit 102. The transmission beam switching unit 103 transmits the acquired signal to the terminal station 30 by the terminal station side transmission antenna 113.

The control signal transmission/reception unit 104 receives the control signal transmitted from the base station 20 by the control signal transmission/reception antenna 114. The control signal transmission/reception unit 104 outputs the received control signal to the control signal generation/processing unit 105. Also, the control signal transmission/reception unit 104 transmits the control signal outputted from control signal generation/processing unit 105. The control signal transmission/reception unit 104 transmits the acquired control signal to the base station 20 by the control signal transmission/reception antenna 114.

The control signal generation/processing unit 105 outputs a beam switching instruction to the beam control unit 106 based on the control signal outputted from the control signal transmission/reception unit 104. The control signal generation/processing unit 105 generates the control signal for controlling the base station 20 and outputs the control signal to the control signal transmission/reception unit.

The beam control unit 106 outputs the beam switching instruction outputted from the control signal generation/processing unit 105 to the reception beam switching unit 101, the transmission beam switching unit 103, the reception beam switching unit 107, and the transmission beam switching unit 109, thereby the switching of the beam forming direction performed by the reception beam switching unit 101, the transmission beam switching unit 103, the reception beam switching unit 107, and the transmission beam switching unit 109 can be controlled.

The reception beam switching unit 107 controls the terminal station side reception antenna 117 to switch the formation direction of the reception beam to the terminal station 30 side. The terminal station side reception antenna 117 receives the signal of wireless communication transmitted from the terminal station 30. The reception beam switching unit 107 acquires the signal received by the terminal station side reception antenna 117 and outputs it to the signal amplifying unit 108.

The signal amplifying unit 108 acquires the signal outputted from the reception beam switching unit 107. The signal amplifying unit 108 electrically amplifies the acquired signal and outputs it to the transmission beam switching unit 109.

The transmission beam switching unit 109 controls the base station side transmission antenna 119 to switch the formation direction of the transmission beam to the base station 20 side. The transmission beam switching unit 109 acquires the amplified signal outputted from the signal amplifying unit 108. The transmission beam switching unit 109 transmits the acquired signal to the base station 20 by the base station side transmission antenna 119.

In the first embodiment, the beam control unit 106 controls the transmission beam switching unit 103 to control the switching of the forming direction of the transmission beam, thereby selecting the discrete beam of the transmission beam to the terminal station 30.

The control signal is transmitted/received to/from the base station 20 by using another wireless signal different from a signal relayed by the non-reproduction wireless relay device 10. The other wireless signal used here may be, for example, a wireless signal based on the same communication standard as the communication standard in the relay of the signal by the non-reproduction wireless relay device 10, or a wireless signal based on a communication standard different from the communication standard in the relay of the signal by the non-reproduction wireless relay device 10.

The other wireless signal used here may be, for example, a wireless signal using a frequency different from the frequency of the signal relayed by the non-reproduction wireless relay device 10, or a wireless signal using the same frequency as the frequency of the signal relayed by the non-reproduction wireless relay device 10. When a wireless signal having the same frequency as the signal relayed by the non-reproduction wireless relay device 10 is used, a mechanism for discriminating the signal to be relayed from the control signal is required in the non-reproduction wireless relay device 10.

In the present embodiment, as an example, the non-reproduction wireless relay device 10 has a signal amplifying unit 102 and a signal amplifying unit 108 for electrically amplifying a signal to be relayed. However, if the non-reproduction wireless relay device 10 is a relay device capable of dynamically changing the reception direction and the transmission direction of the signal to be relayed, the present invention is not limited to this configuration. For example, the non-reproduction wireless relay device 10 may be provided with, for example, a reflector or the like, and may be provided with no signal amplifying unit.

### [Configuration of Base Station]

The functional configuration of the base station 20 will be described below.

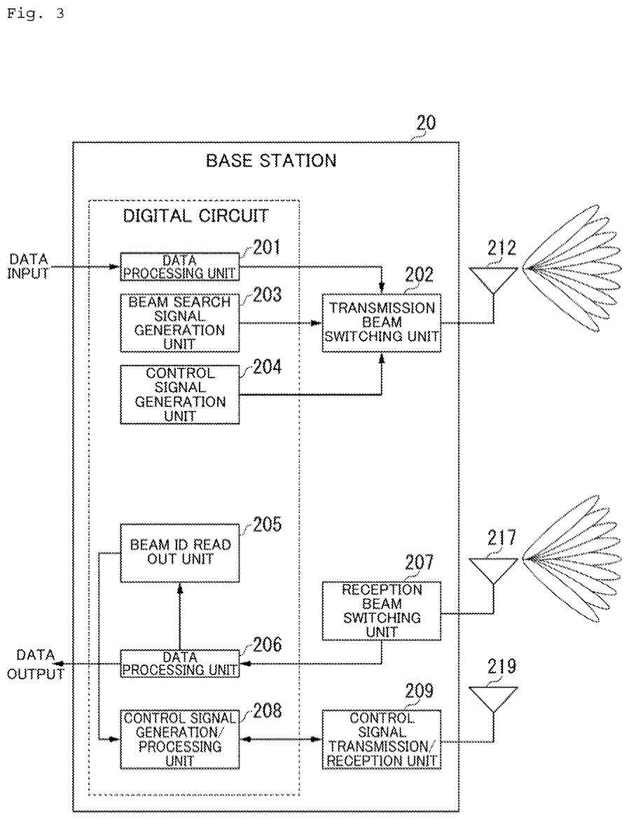

FIG. 3 is a block diagram illustrating the functional configuration of the base station 20 according to the first embodiment of the present invention. As shown in FIG. 3, the base station 20 includes a data processing unit 201, a transmission beam switching unit 202, a beam search signal generation unit 203, a control signal generation unit 204, a beam ID read out unit 205, a data processing unit 206, a reception beam switching unit 207, a control signal generation/processing unit 208, a control signal transmission/reception unit 209, a transmission antenna 212, a reception antenna 217, and a control signal transmission/reception antenna 219.

Among these function units, the data processing unit 201, the beam search signal generation unit 203, the control signal generation unit 204, the beam ID read out unit 205, the data processing unit 206 and the control signal generation/processing unit 208 are constituted by the digital processing circuits.

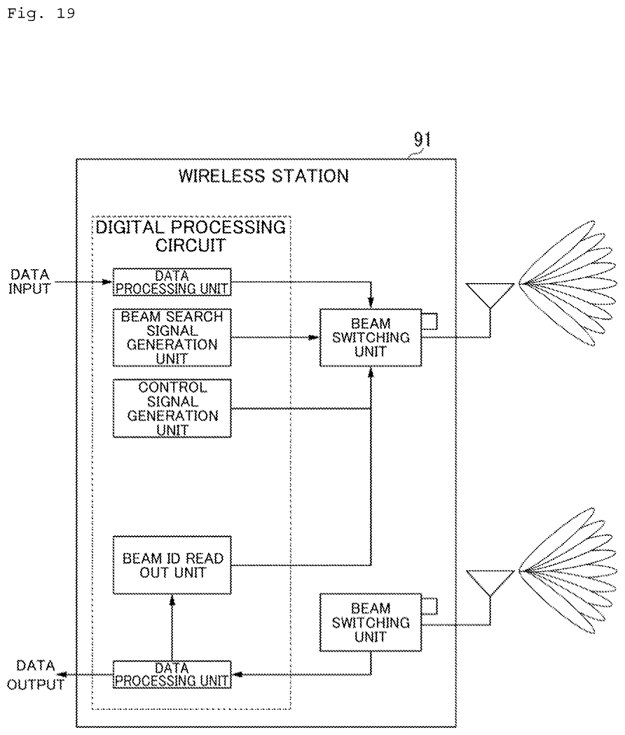

As shown in FIG. 3, the configuration of the base station 20 according to the first embodiment is the configuration in which the control signal generation/processing unit 208, the control signal transmission/reception unit 209, and the control signal transmission/reception antenna 219 are further added, as compared with the configuration of the wireless station 91 on the transmission side that performs the conventional discrete beam selection as shown in FIG. 19.

The data processing unit 201 acquires transmission data from external equipment, and converts the acquired transmission data into a signal (an electric signal). The data processing unit 201 outputs the signal to the transmission beam switching unit 202.

The transmission beam switching unit 202 acquires the beam search signal outputted from the beam search signal generation unit 203. The transmission beam switching unit 202 transmits the beam search signal to the non-reproduction wireless relay device 10 by the transmission antenna 212.

The transmission beam switching unit 202 acquires a control signal such as a transmission request signal of the reception beam search signal generated by the control signal generation unit 204, and transmits the control signal to the non-reproduction wireless relay device 10 by the transmission antenna 212.

The beam search signal generation unit 203 generates the beam search signal in which the beam ID of each transmission beam (each candidate beam) on the terminal station side of the non-reproduction wireless relay device 10 is embedded when the transmission timing comes. The beam search signal generation unit 203 outputs the generated beam search signal to the transmission beam switching unit 202.

The control signal generation unit 204 generates the control signal such as the transmission request signal of the reception beam search signal to the terminal station 30. The transmission request signal of the reception beam search signal is a signal for requesting the terminal station 30 to transmit the beam search signal (the reception beam search signal) to the non-reproduction wireless relay device 10.

The beam ID read out unit 205 acquires the reception data outputted from the data processing unit 206. The beam ID read out unit 205 reads out the beam ID embedded in the acquired reception data. The beam ID read out unit 205 outputs information indicating the read out beam ID to the control signal generation/processing unit 208.

The data processing unit 206 acquires the signal outputted from the reception beam switching unit 207, and converts the acquired signal into reception data. The data processing unit 206 outputs the reception data to the external equipment.

The reception beam switching unit 207 acquires a signal received by the reception antenna 217 and transmitted from the non-reproduction wireless relay device 10. The reception beam switching unit 207 outputs the acquired data to the data processing unit 206.

When the reception beam switching unit 207 receives the beam ID feedback signal by the reception antenna 217, the data processing unit 206 outputs the reception data based on the beam ID feedback signal to the beam ID read out unit 205.

The control signal generation/processing unit 208 acquires the information indicating the beam ID outputted from the beam ID read out unit 205. The control signal generation/processing unit 208 outputs a control signal for instructing switching to the beam ID to the control signal transmission/reception unit 209.

The control signal generation/processing unit 208 generates discrete beam selection execution information indicating that discrete beam selection of the transmission beam to the terminal station 30 side of the non-reproduction wireless relay device 10 is performed, and timing information indicating transmission timing of the beam search signal used in the discrete beam search selection. The control signal generation/processing unit 208 outputs the generated discrete beam selection execution information and timing information to the control signal transmission/reception unit 209.

The control signal transmission/reception unit 209 transmits the control signal for instructing switching to a specific beam ID outputted from the control signal generation/processing unit 208 to the non-reproduction wireless relay device 10 by the control signal transmission/reception antenna 219 (a beam ID notification). The control signal transmission/reception unit 209 acquires the discrete beam selection execution information and timing information outputted from the control signal generation/processing unit 208. The control signal transmission/reception unit 209 transmits the acquired discrete beam selection execution information and timing information to the non-reproduction wireless relay device 10 by the control signal transmission/reception antenna 219.

### [Operation of Base Station]

The following describes an example of operations of the base station 20 below.

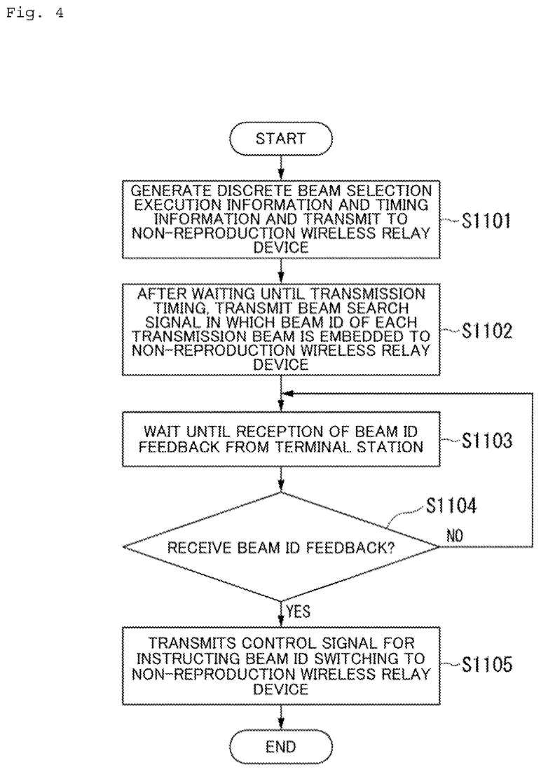

FIG. 4 is a flowchart illustrating the operation of the base station 20 according to the first embodiment of the present invention. The operation of the base station 20 shown in the flowchart of FIG. 4 is started when the base station 20 performs the discrete beam selection of the transmission beam to the terminal station 30 side of the non-reproduction wireless relay device 10.

The control signal generation/processing unit 208 of the base station 20 generates the discrete beam selection execution information indicating that the discrete beam selection of the transmission beam to the terminal station 30 side of the non-reproduction wireless relay device 10 is performed, and timing information indicating transmission timing of the beam search signal used in the discrete beam search selection. The control signal generation/processing unit 208 outputs the generated discrete beam selection execution information and timing information to the control signal transmission/reception unit 209.

The control signal transmission/reception unit 209 of the base station 20 acquires the discrete beam selection execution information and timing information outputted from the control signal generation/processing unit 208. The control signal transmission/reception unit 209 transmits the acquired discrete beam selection execution information and timing information to the non-reproduction wireless relay device 10 by the control signal transmission/reception antenna 219 (step S1101).

Next, the base station 20 waits until the transmission timing based on the timing information transmitted to the non-reproduction wireless relay device 10 comes. When the transmission timing comes, the beam search signal generation unit 203 of the base station 20 generates the beam search signal in which the beam ID of each transmission beam (each candidate beam) on the terminal station side of the non-reproduction wireless relay device 10 is embedded. The beam search signal generation unit 203 outputs the generated beam search signal to the transmission beam switching unit 202.

The transmission beam switching unit 202 acquires the beam search signal outputted from the beam search signal generation unit 203. The transmission beam switching unit 202 transmits the beam search signal to the non-reproduction wireless relay device 10 without switching the formation direction of the transmission beam by the transmission antenna 212 (step S1102).

Next, the base station 20 waits until the beam ID feedback signal outputted from the terminal station 30 is received from the non-reproduction wireless relay device 10 (step S1103). The beam ID feedback signal mentioned here is a signal including information indicating the beam ID selected by the terminal station 30. When the reception beam switching unit 207 receives the beam ID feedback signal by the reception antenna 217 (step S1104, YES), the data processing unit 206 outputs reception data based on the beam ID feedback signal to the beam ID read out unit 205.

The beam ID read out unit 205 reads out the beam ID from the acquired reception data, and outputs the information indicating the read out beam ID to the control signal generation/processing unit 208. The control signal generation/processing unit 208 generates the control signal for instructing beam ID switching from the information indicating the beam ID based on the beam ID feedback signal, and outputs the control signal to the control signal transmission/reception unit 209. The control signal transmission/reception unit 209 transmits the control signal for instructing beam ID switching to the non-reproduction wireless relay device 10 by the control signal transmission/reception antenna 219 (step S1105, the beam ID notification).

This completes the operations of the base station 20 shown in the flowchart of FIG. 4.

### [Operation of Non-Reproduction Wireless Relay Device]

The following describes an example of operations of the non-reproduction wireless relay device 10.

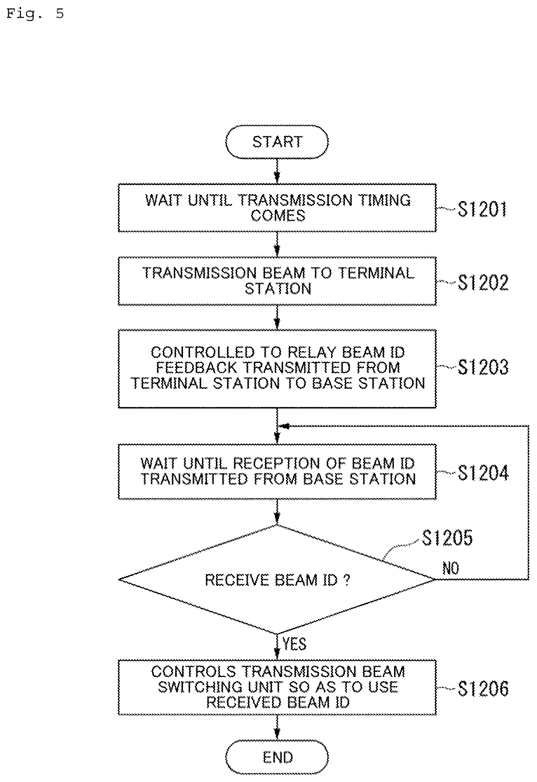

FIG. 5 is a flowchart illustrating the operation of the non-reproduction wireless relay device 10 according to the first embodiment of the present invention. The operation of the non-reproduction wireless relay device 10 shown in the flowchart of FIG. 5 is started when the control signal transmission/reception unit 104 of the non-reproduction wireless relay device 10 receives the discrete beam selection execution information and timing information transmitted from the base station 20 by the control signal transmission/reception antenna 114 in the step S1101 of the flowchart illustrated in FIG. 4.

The non-reproduction wireless relay device 10 waits until the transmission timing based on the timing information received by the control signal transmission/reception unit 104 comes (step S1201). When the transmission timing comes, the beam control unit 106 controls the transmission beam switching unit 103 to switch the forming direction of the transmission beam formed by the terminal station side transmission antenna 113 (step S1202).

Thus, the non-reproduction wireless relay device 10 becomes in a state to relay the transmission of the signal from the base station 20 to the terminal station 30 while switching the forming direction of the transmission beam on the terminal station 30 side.

At this time, the base station 20 transmits the beam search signal in which the beam ID corresponding to each transmission beam (each candidate beam) to the terminal station 30 side of the non-reproduction wireless relay device 10 is embedded to the non-reproduction wireless relay device 10 (mentioned above step S1102 of FIG. 4). As a result, the beam search signal in which the beam IDs corresponding to the respective transmission beams are embedded is superimposed on the respective transmission beams transmitted to the terminal station 30 side by the non-reproduction wireless relay device 10.

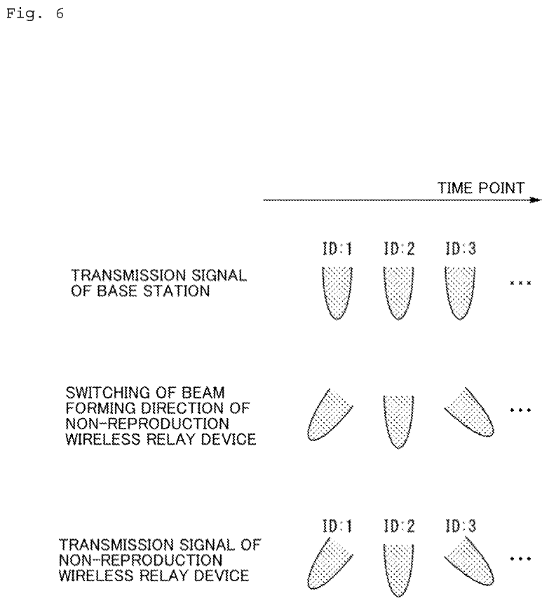

FIG. 6 is a schematic diagram illustrating the relationship between the beam search signal transmitted by the base station 20 and the switching of the transmission beam by the non-reproduction wireless relay device 10 according to the first embodiment of the present invention. As shown in FIG. 6, the base station 20 sequentially transmits beam search signals in which beam IDs are embedded to the non-reproduction wireless relay device 10 when the transmission timing comes. Further, the non-reproduction wireless relay device 10 sequentially switches transmission beams set discretely when transmission timing comes. Thus, the beam ID corresponding to the transmission beam used for transmitting the signal is superimposed on the signal transmitted from the non-reproduction wireless relay device 10 to the terminal station 30.

When the switching of the transmission beam is completed, the beam control unit 106 of the non-reproduction wireless relay device 10 controls the reception beam switching unit 107 and the transmission beam switching unit 109 so that transmission of the beam ID feedback signal from the terminal station 30 to the base station 20 can be relayed by using the terminal station side reception antenna 117 and the base station side transmission antenna 119 (step S1203). When relaying the transmission of the beam ID feedback signal from the terminal station 30 to the base station 20, the non-reproduction wireless relay device 10 waits until receiving the information (the beam ID notification) indicating the beam ID transmitted from the base station 20 (step S1204).

When the control signal transmission/reception unit 104 of the non-reproduction wireless relay device 10 receives the information indicating the beam ID transmitted from the base station 20 by the control signal transmission/reception antenna 114 (the step S1205, YES), the beam control unit 26 controls the transmission beam switching unit 103 so that the signal of wireless communication is relayed by using the transmission beam corresponding to the beam ID based on the received information (step S1206).

With that, the operation of the non-reproduction wireless relay device 10 indicated by the flowchart of FIG. 5 ends.

With the above-described configuration, the wireless communication system 1 according to the first embodiment can control the switching of the transmission beam to the terminal station side in the relay device by the signal (the control signal) different from the signal relayed by the relay device. Thus, in the wireless communication system 1 according to the first embodiment, even if the relay device does not have the digital processing circuit for performing the digital processing on the signal to be relayed, the discrete beam selection of the transmission beam to the terminal station side in the relay device can be performed.

### Second Embodiment

The second embodiment of the present invention will be described below.

The wireless communication system 1 according to the first embodiment has the configuration in which discrete beam selection of the transmission beam to the terminal station side of the non-reproduction wireless relay device 10 is performed. On the other hand, the wireless communication system according to the second embodiment described below is a communication system capable of selecting the discrete beam of the transmission beam to the base station side of the non-reproduction wireless relay device.

The entire configuration diagram of the wireless communication system according to the second embodiment is the same as the entire configuration diagram of the wireless communication system 1 according to the first embodiment shown in FIG. 1. The block diagram illustrating the functional configuration of the non-reproduction wireless relay device and the block diagram illustrating the functional configuration of the base station according to the second embodiment are the same as the block diagram illustrating the functional configuration of the non-reproduction wireless relay device 10 and the block diagram illustrating the functional configuration of the base station 20 according to the first embodiment illustrated in FIGS. 2 and 3.

In order to make the explanation easier to understand, a wireless communication system, each device, and each function unit according to the second embodiment have the same reference numerals as those corresponding to the wireless communication system, the respective devices, and the respective function units according to the first embodiment and will be described.

### [Operation of Base Station]

The following describes an example of operation of the base station 20.

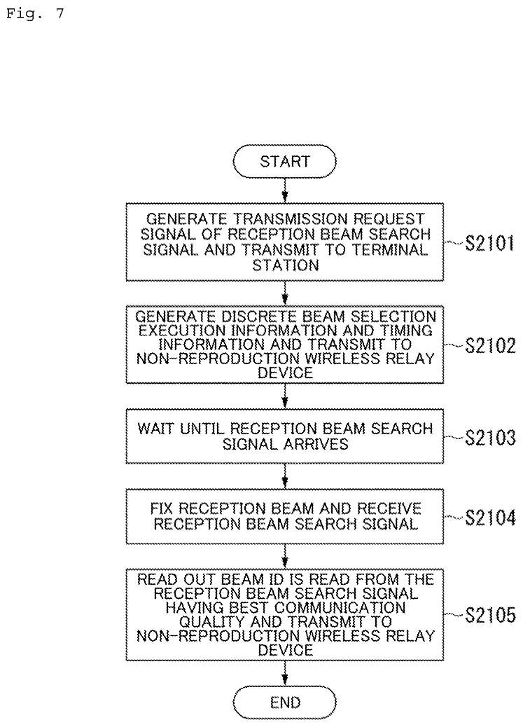

FIG. 7 is a flowchart illustrating the operation of the base station 20 according to the second embodiment of the present invention. The operation of the base station 20 shown in the flowchart of FIG. 7 is started when the base station 20 executes the discrete beam selection of the transmission beam to the base station 20 side of the non-reproduction wireless relay device 10.

The control signal generation unit 204 of the base station 20 generates the transmission request signal of the reception beam search signal to be transmitted to the terminal station 30. The transmission request signal of the reception beam search signal mentioned here is the signal for requesting the terminal station 30 to transmit the beam search signal (the reception beam search signal) to the non-reproduction wireless relay device 10. The control signal generation unit 204 outputs the transmission request signal of the generated reception beam search signal to the transmission beam switching unit 202.

The transmission beam switching unit 202 of the base station 20 acquires the transmission request signal of the reception beam search signal outputted from the control signal generation unit 204. The transmission beam switching unit 202 transmits the transmission request signal of the acquired reception beam search signal to the terminal station 30 by the transmission antenna 212 (via the non-reproduction wireless relay device 10) (step S2101).

The control signal generation/processing unit 208 generates discrete beam selection execution information indicating that discrete beam selection of the transmission beam to the base station 20 side of the non-reproduction wireless relay device 10 is performed. The control signal generation/processing unit 208 the generates timing information indicating arrival timing at which the reception beam search signal used in the discrete beam search selection arrives from the terminal station 30 to the non-reproduction wireless relay device 10. The control signal generation/processing unit 208 outputs the generated discrete beam selection execution information and timing information to the control signal transmission/reception unit 209.

The control signal transmission/reception unit 209 acquires the discrete beam selection execution information and timing information outputted from the control signal generation/processing unit 208. The control signal transmission/reception unit 209 transmits the acquired discrete beam selection execution information and timing information to the non-reproduction wireless relay device 10 by the control signal transmission/reception antenna 219 (step S2102).

Next, the base station 20 waits until the reception beam search signal transmitted from the terminal station 30 on the basis of the transmitted timing information arrives (via the non-reproduction wireless relay device 10) (step S2103). The reception beam switching unit 207 of the base station 20 controls the reception antenna 217 to fix the reception beam and receives the reception beam search signal (step S2104).

The data processing unit 206 of the base station 20 determines which reception beam search signal has the best communication quality among reception beam search signals transmitted from the non-reproduction wireless relay device 10 to the base station 20 by each transmission beam (each candidate beam). The beam ID read out unit 205 reads out the beam ID from the received beam search signal determined by the data processing unit 206 to have the best communication quality.

The control signal generation/processing unit 208 generates information indicating the read out beam ID and outputs the information to the control signal transmission/reception unit 209. The control signal transmission/reception unit 209 acquires the information indicating the beam ID outputted from the control signal generation/processing unit 208. The control signal transmission/reception unit 209 transmits the information indicating the acquired beam ID to the non-reproduction wireless relay device 10 by the control signal transmission/reception antenna 219 (step S2105). This completes the operations of the base station 20 shown in the flowchart of FIG. 7.

### [Operation of Non-Reproduction Wireless Relay Device]

The following describes an example of operation of the non-reproduction wireless relay device 10.

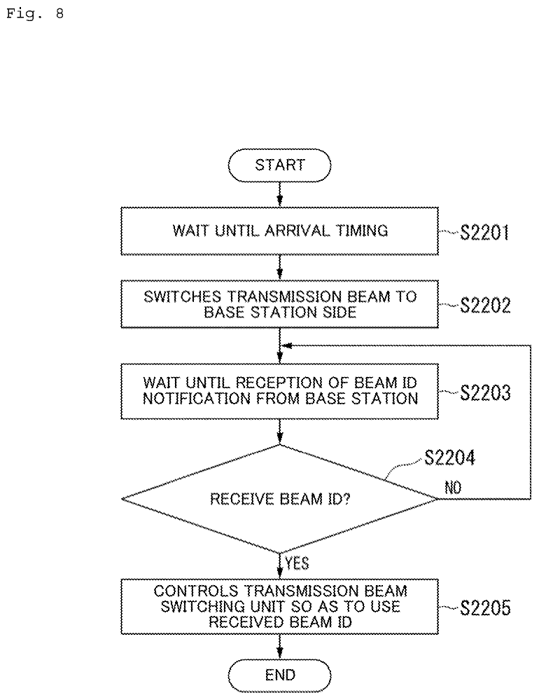

FIG. 8 is a flowchart illustrating the operation of the non-reproduction wireless relay device 10 according to the second embodiment of the present invention. The operation of the non-reproduction wireless relay device 10 shown by the flowchart of FIG. 8 is started when the control signal transmission/reception unit 104 of the non-reproduction wireless relay device 10 receives the discrete beam selection execution information and timing information transmitted from the base station 20 by the control signal transmission/reception antenna 114 in the step S2102 of the flowchart illustrated in FIG. 7.

The non-reproduction wireless relay device 10 waits until arrival timing of the reception beam search signal based on the timing information received by the control signal transmission/reception unit 104 comes (step S2201). When the arrival timing comes, the beam control unit 106 controls the transmission beam switching unit 109 to switch the forming direction of the transmission beam formed by the base station side transmission antenna 119 (step S2202).

Thus, the non-reproduction wireless relay device 10 becomes the state to relay the transmission of the signal from the terminal station 30 to the base station 20 while switching the forming direction of the transmission beam on the base station 20 side.

At this time, the terminal station 30 transmits to the non-reproduction wireless relay device 10 the beam search signal (the reception beam search signal) in which the beam ID corresponding to each transmission beam (each candidate beam) to the base station 20 side of the non-reproduction wireless relay device 10 is embedded based on the transmission request signal of the received reception beam search signal.

Generally, the digital signal for identifying what number of the beam on which the signal is superimposed among the candidate beams is embedded in the reception beam search signal. Therefore, the digital signal can be used as the beam ID.

Further, the number of generated reception beam search signals can be defined by the transmission request signal of the reception beam search signal transmitted from the base station 20. Thus, the base station 20 collects information indicating the number of transmission beams (candidate beams) to the base station 20 side of the non-reproduction wireless relay device 10 in advance from the non-reproduction wireless relay device 10, and thereby can generate reception beam search signals for the number of transmission beams (candidate beams) to the base station 20 side of the non-reproduction wireless relay device 10.

Thus, the wireless communication system 1 according to the second embodiment can use the reception beam search signal for the discrete beam selection of the transmission beam to the base station 20 side in the non-reproduction wireless relay device 10 by reading out the beam ID embedded in the reception beam search signal.

When the switching of the transmission beam is completed, the non-reproduction wireless relay device 10 waits until the reception (the beam ID notification) of the information indicating the beam ID transmitted from the base station 20 is given (step S2203).

When the control signal transmission/reception unit 104 of the non-reproduction wireless relay device 10 receives the information indicating the beam ID transmitted from the base station 20 by the control signal transmission/reception antenna 114 (the step S2204, YES), the beam control unit 106 controls the transmission beam switching unit 109 so that the signal of wireless communication is relayed by using a transmission beam corresponding to the beam ID based on the received information (step S2205).

With that, the operation of the non-reproduction wireless relay device 10 indicated by the flowchart of FIG. 8 ends.

With the above-described configuration, the wireless communication system 1 according to the second embodiment can control the switching of the transmission beam to the base station side in the relay device by the different signal (the control signal) from the signal relayed by the relay device. Thus, in the wireless communication system 1 according to the second embodiment, even if the relay device does not have the digital processing circuit for performing digital processing on the signal to be relayed, the discrete beam selection of the transmission beam to the base station side in the relay device can be performed.

### Third Embodiment

The third embodiment of the present invention will be described below.

The wireless communication system 1 according to the first embodiment has the configuration in which discrete beam selection of the transmission beam to the terminal station side of the non-reproduction wireless relay device 10 is performed. On the other hand, the wireless communication system according to the third embodiment described below is a communication system capable of selecting a discrete beam of a reception beam to the terminal station side of the non-reproduction wireless relay device.

The entire configuration diagram of the wireless communication system according to the third embodiment is the same as the entire configuration diagram of the wireless communication system 1 according to the first embodiment shown in FIG. 1. The block diagram illustrating the functional configuration of the non-reproduction wireless relay device and the block diagram illustrating the functional configuration of the base station according to the third embodiment are the same as the block diagram illustrating the functional configuration of the non-reproduction wireless relay device 10 according to the first embodiment shown in FIGS. 2 and 3 and the block diagram illustrating the functional configuration of the base station 20.

In order to make the explanation easier to understand, a wireless communication system, each device, and each function unit according to the third embodiment have the same reference numerals as those corresponding to the wireless communication system, the respective devices, and the respective function units according to the first embodiment and will be described.

### [Operation of Base Station]

The following describes an example of the operation of the base station 20.

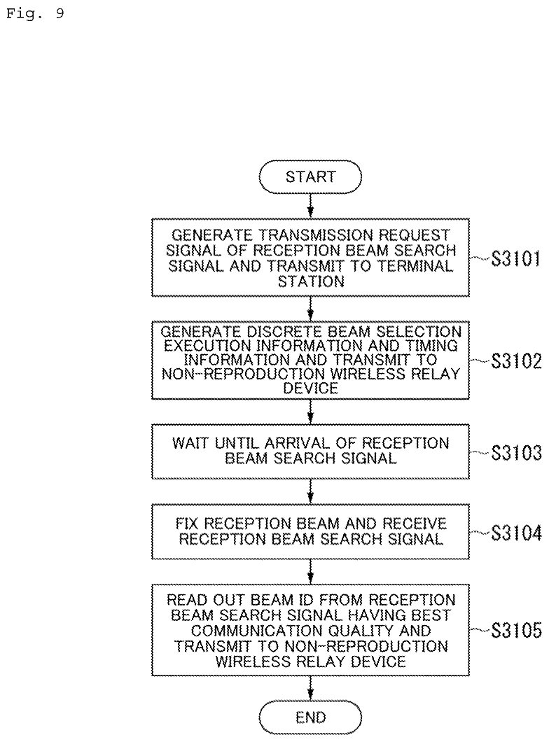

FIG. 9 is a flowchart illustrating the operation of the base station 20 according to the third embodiment. The operation of the base station 20 illustrated in the flowchart of FIG. 9 is started when the base station 20 executes the discrete beam selection of the reception beam to the terminal station 30 side of the non-reproduction wireless relay device 10.

The control signal generation unit 204 of the base station 20 generates the transmission request signal of the reception beam search signal to be transmitted to the terminal station 30. The transmission request signal of the reception beam search signal is the signal for requesting the terminal station 30 to transmit the beam search signal (the reception beam search signal) to the non-reproduction wireless relay device 10. The control signal generation unit 204 outputs the transmission request signal of the generated reception beam search signal to the transmission beam switching unit 202.

The transmission beam switching unit 202 of the base station 20 acquires the transmission request signal of the reception beam search signal outputted from the control signal generation unit 204. The transmission beam switching unit 202 transmits the transmission request signal of the acquired reception beam search signal to the terminal station 30 via the non-reproduction wireless relay device 10 by the transmission antenna 212 (step S3101).

The control signal generation/processing unit 208 generates discrete beam selection execution information indicating that discrete beam selection of the reception beam to the terminal station 30 side of the non-reproduction wireless relay device 10 is performed. The control signal generation/processing unit 208 generates timing information indicating arrival timing at which the reception beam search signal used in the discrete beam search selection arrives from the terminal station 30 to the non-reproduction wireless relay device 10. The control signal generation/processing unit 208 outputs the generated discrete beam selection execution information and timing information to the control signal transmission/reception unit 209.

The control signal transmission/reception unit 209 acquires the discrete beam selection execution information and timing information outputted from the control signal generation/processing unit 208. The control signal transmission/reception unit 209 transmits the acquired discrete beam selection execution information and timing information to the non-reproduction wireless relay device 10 by the control signal transmission/reception antenna 219 (step S3102).

Next, the base station 20 waits until the reception beam search signal transmitted from the terminal station 30 on the basis of the transmitted timing information arrives (via the non-reproduction wireless relay device 10) (step S3103). The reception beam switching unit 207 of the base station 20 controls the reception antenna 217 to fix the reception beam and receives the reception beam search signal (step S3104).

The data processing unit 206 of the base station 20 determines which reception beam search signal has the best communication quality among reception beam search signals transmitted from the non-reproduction wireless relay device 10 to the base station 20 by each transmission beam (each candidate beam). The beam ID read out unit 205 reads out the beam ID from the received beam search signal determined by the data processing unit 206 to have the best communication quality.

The control signal generation/processing unit 208 generates information indicating the read out beam ID and outputs the information to the control signal transmission/reception unit 209. The control signal transmission/reception unit 209 acquires the information indicating the beam ID outputted from the control signal generation/processing unit 208. The control signal transmission/reception unit 209 transmits the information indicating the acquired beam ID to the non-reproduction wireless relay device 10 by the control signal transmission/reception antenna 219 (step S3105).

This completes the operations of the base station 20 illustrated in the flowchart of FIG. 9.

### [Operation of Non-Reproduction Wireless Relay Device]

The following describes an example of the operation of the non-reproduction wireless relay device 10.

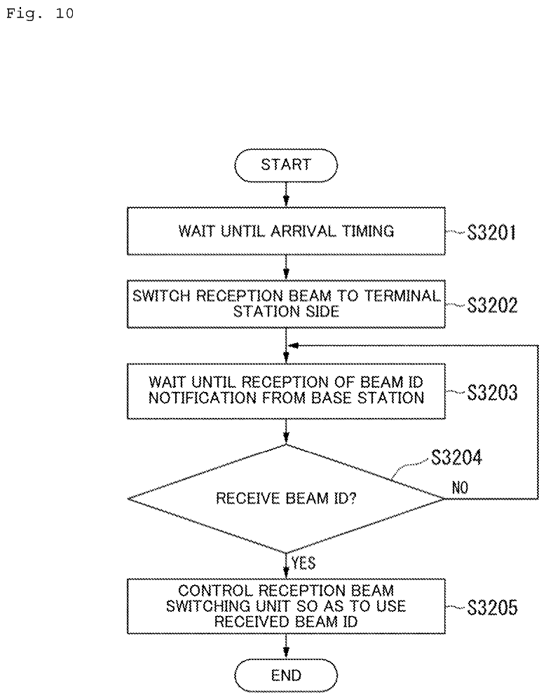

FIG. 10 is a flowchart illustrating the operation of the non-reproduction wireless relay device 10 according to the third embodiment of the present invention. The operation of the non-reproduction wireless relay device 10 illustrated in the flowchart of FIG. 10 is started when the control signal transmission/reception unit 104 of the non-reproduction wireless relay device 10 receives the discrete beam selection execution information and the timing information transmitted from the base station 20 by the control signal transmission/reception antenna 114 in the step S3102 of the flowchart illustrated in FIG. 9.

The non-reproduction wireless relay device 10 waits until arrival timing of the reception beam search signal based on the timing information received by the control signal transmission/reception unit 104 comes (step S3201). When the arrival timing comes, the beam control unit 106 controls the reception beam switching unit 107 to switch the formation direction of the reception beam formed by the terminal station side reception antenna 117 (step S3202).

Thus, the non-reproduction wireless relay device 10 becomes the state to relay transmission of the signal from the terminal station 30 to the base station 20 while switching the formation direction of the reception beam on the terminal station 30 side.

At this time, the terminal station 30 transmits to the non-reproduction wireless relay device 10 the beam search signal in which the beam ID corresponding to each reception beam (each candidate beam) to the terminal station 30 side of the non-reproduction wireless relay device 10 is embedded based on the transmission request signal for the received reception beam search signal.

Generally, the digital signal for identifying what number of the beam on which the signal is superimposed among the candidate beams is embedded in the reception beam search signal. Therefore, the digital signal can be used as the beam ID.

Further, the number of generated reception beam search signals can be defined by the transmission request signal of the reception beam search signal transmitted from the base station 20. Thus, the base station 20 collects the information indicating the number of the reception beams (the candidate beams) to the terminal station 30 side of the non-reproduction wireless relay device 10 in advance from the non-reproduction wireless relay device 10, and thereby can generate reception beam search signals for the number of reception beams (candidate beams) to the terminal station 30 side of the non-reproduction wireless relay device 10.

Thus, the wireless communication system 1 according to the third embodiment can use the reception beam search signal for the discrete beam selection of the reception beam to the terminal station 30 side in the non-reproduction wireless relay device 10 by reading out the beam ID embedded in the reception beam search signal.

When the switching of the transmission beam is completed, the non-reproduction wireless relay device 10 waits until a reception (the beam ID notification) of the information indicating the beam ID transmitted from the base station 20 is given (step S3203).

When the control signal transmission/reception unit 104 of the non-reproduction wireless relay device 10 receives the information indicating the beam ID transmitted from the base station 20 by the control signal transmission/reception antenna 114 (step S3204, YES), the beam control unit 26 controls the reception beam switching unit 107 so that the signal of wireless communication is relayed by using the transmission beam corresponding to the beam ID based on the received information (step S3205).

With that, the operation of the non-reproduction wireless relay device 10 indicated by the flowchart of FIG. 10 ends.

With the above-described configuration, the wireless communication system 1 according to the third embodiment can control the switching of the reception beam to the terminal station side in the relay device by the different signal (the control signal) from the signal relayed by the relay device. Thus, in the wireless communication system 1 according to according to the third embodiment, even if the relay device does not have the digital processing circuit for performing the digital processing on the signal to be relayed, the discrete beam selection of the reception beam to the terminal station side in the relay device can be performed.

### Fourth Embodiment

The fourth embodiment of the present invention will be described below.

The wireless communication system 1 according to the first embodiment has the configuration in which the discrete beam selection of a transmission beam to the terminal station side of the non-reproduction wireless relay device 10 is performed.

On the other hand, the wireless communication system according to the fourth embodiment described below is a communication system capable of performing a discrete beam selection of a reception beam to the base station side of the non-reproduction wireless relay device.

The entire configuration diagram of the wireless communication system according to the fourth embodiment is the same as the entire configuration diagram of the wireless communication system 1 according to the first embodiment shown in FIG. 1. The block diagram illustrating the functional configuration of the non-reproduction wireless relay device and the block diagram illustrating the functional configuration of the base station according to the fourth embodiment are the same as the block diagram illustrating the functional configuration of the non-reproduction wireless relay device 10 and the block diagram illustrating the functional configuration of the base station 20 according to the first embodiment shown in FIGS. 2 and 3.

In order to make the explanation easier to understand, a wireless communication system, each device, and each function unit according to the fourth embodiment have the same reference numerals as those corresponding to the wireless communication system, the respective devices, and the respective function units according to the first embodiment and will be described.

### [Operation of Base Station]

The following describes an example of the operation of the base station 20.

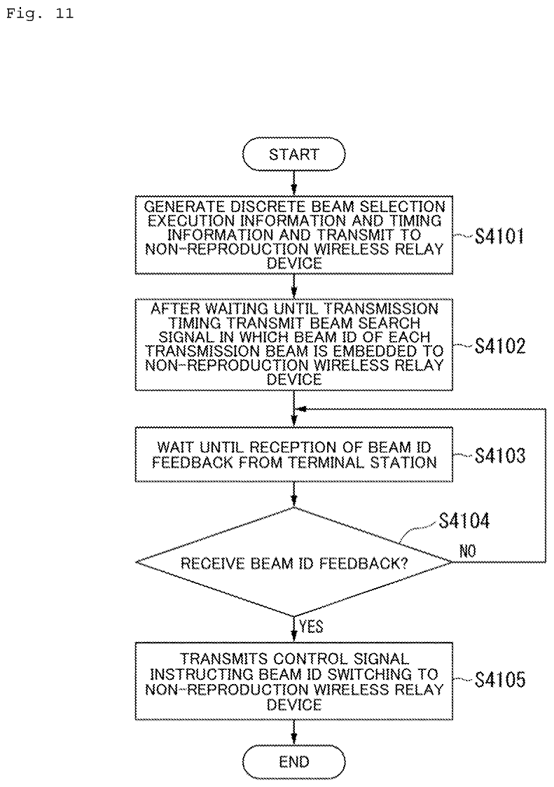

FIG. 11 is a flowchart illustrating the operation of the base station 20 according to the fourth embodiment. The operation of the base station 20 shown in the flowchart of FIG. 11 is started when the base station 20 execute the discrete beam selection of the reception beam to the base station 20 side of the non-reproduction wireless relay device 10.

The control signal generation/processing unit 208 of the base station 20 generates discrete beam selection execution information indicating that discrete beam selection of the reception beam to the base station 20 side of the non-reproduction wireless relay device 10 is performed, and timing information indicating transmission timing of the beam search signal used in the discrete beam search selection. The control signal generation/processing unit 208 outputs the generated discrete beam selection execution information and timing information to the control signal transmission/reception unit 209.

The control signal transmission/reception unit 209 of the base station 20 acquires the discrete beam selection execution information and the timing information outputted from the control signal generation/processing unit 208. The control signal transmission/reception unit 209 transmits the acquired the discrete beam selection execution information and the timing information to the non-reproduction wireless relay device 10 by the control signal transmission/reception antenna 219 (step S4101).

Next, the base station 20 waits until the transmission timing based on the timing information transmitted to the non-reproduction wireless relay device 10 comes. When the transmission timing comes, the beam search signal generation unit 203 of the base station 20 generates the beam search signal in which the beam ID of each reception beam (each candidate beam) of the base station 20 side of the non-reproduction wireless relay device 10 is embedded. The beam search signal generation unit 203 outputs the generated beam search signal to the transmission beam switching unit 202.

The transmission beam switching unit 202 acquires the beam search signal outputted from the beam search signal generation unit 203. The transmission beam switching unit 202 transmits the beam search signal to the non-reproduction wireless relay device 10 without switching the formation direction of the transmission beam by the transmission antenna 212 (step S4102).

Next, the base station 20 waits until the beam ID feedback signal outputted from the terminal station 30 is received from the non-reproduction wireless relay device 10 (step S4103). The beam ID feedback signal, mentioned here, is a signal including information indicating the beam ID selected by the terminal station 30. When the reception beam switching unit 207 receives the beam ID feedback signal by the reception antenna 217 (step S4104, YES), the data processing unit 206 outputs reception data based on the beam ID feedback signal to the beam ID read out unit 205.

The beam ID read out unit 205 reads out the beam ID from the acquired reception data, and outputs the information indicating the read out beam ID to the control signal generation/processing unit 208. The control signal generation/processing unit 208 generates the control signal for instructing beam ID switching from the information indicating the beam ID based on the beam ID feedback signal, and outputs the control signal to the control signal transmission/reception unit 209. The control signal transmission/reception unit 209 transmits the control signal instructing beam ID switching to the non-reproduction wireless relay device 10 by the control signal transmission/reception antenna 219 (step S4105, the beam ID notification). This completes the operation of the base station 20 shown in the flowchart of FIG. 11.

### [Operation of Non-Reproduction Wireless Relay Device]

The following describes an example of the operation of the non-reproduction wireless relay device 10.

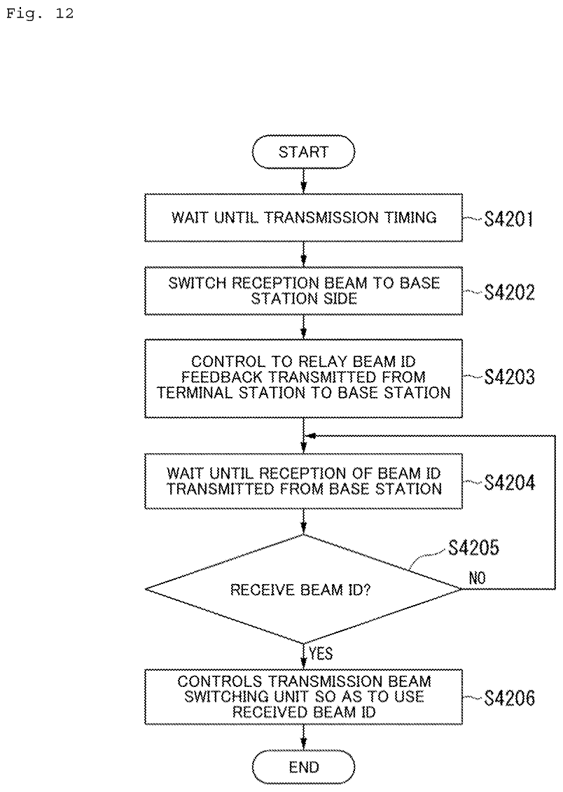

FIG. 12 is a flowchart illustrating the operation of the non-reproduction wireless relay device 10 according to the fourth embodiment. The operation of the non-reproduction wireless relay device 10 illustrated by the flowchart of FIG. 12 is started when the control signal transmission/reception unit 104 of the non-reproduction wireless relay device 10 receives the discrete beam selection execution information and the timing information transmitted from the base station 20 by the control signal transmission/reception antenna 114 in the step S4101 of the flowchart illustrated in FIG. 11.

The non-reproduction wireless relay device 10 waits until transmission timing based on the timing information received by the control signal transmission/reception unit 104 comes (step S4201). When the transmission timing comes, the beam control unit 106 controls the reception beam switching unit 101 to switch the formation direction of the reception beam formed by the base station side reception antenna 111 (step S4202).

Thus, the non-reproduction wireless relay device 10 becomes the state to relay the transmission of the signal from the base station 20 to the terminal station 30 while switching the formation direction of the reception beam on the base station 20 side.

At this time, the base station 20 transmits the beam search signal in which the beam ID corresponding to each the reception beam (each candidate beam) to the base station 20 side of the non-reproduction wireless relay device 10 is embedded to the non-reproduction wireless relay device 10 (the step S4102 of above mentioned FIG. 11). As a result, the beam search signal in which the beam IDs corresponding to the respective reception beams are embedded is superimposed on the signal received by the respective reception beams to the base station 20 side in the non-reproduction wireless relay device 10.

When the switching of the reception beam is completed, the beam control unit 106 of the non-reproduction wireless relay device 10 controls the reception beam switching unit 107 and the transmission beam switching unit 109 so that transmission of the beam ID feedback signal from the terminal station 30 to the base station 20 can be relayed by using the terminal station side reception antenna 117 and the base station side transmission antenna 119 (step S4203). When relaying transmission of the beam ID feedback signal from the terminal station 30 to the base station 20, the non-reproduction wireless relay device 10 waits until receiving (the beam ID notification) of the information indicating the beam ID transmitted from the base station 20 (step S4204).

When the control signal transmission/reception unit 104 of the non-reproduction wireless relay device 10 receives the information indicating the beam ID transmitted from the base station 20 by the control signal transmission/reception antenna 114 (the step S4205, YES), the beam control unit 26 controls the reception beam switching unit 101 so that the signal of wireless communication is relayed by using the reception beam corresponding to the beam ID based on the received information (step S4206).

With that, the operation of the non-reproduction wireless relay device 10 indicated by the flowchart of FIG. 12 ends.

With the above-described configuration, the wireless communication system 1 according to the fourth embodiment can control the switching of the reception beam to the base station side in the relay device by the different signal (the control signal) from the signal relayed by the relay device. Thus, in the wireless communication system 1 according to the fourth embodiment, even if the relay device does not have the digital processing circuit for performing the digital processing on the signal to be relayed, the discrete beam selection of the reception beam to the base station side in the relay device can be performed.

### Fifth Embodiment

The wireless communication system 1 according to the first embodiment has the configuration in which the discrete beam selection of the transmission beam to the terminal station side of the non-reproduction wireless relay device 10 is performed. On the other hand, the wireless communication system according to the fifth embodiment described below is a communication system capable of performing the discrete beam selection of the reception beam to the terminal station side of the non-reproduction wireless relay device.

The entire configuration diagram of the wireless communication system according to the fifth embodiment is the same as the entire configuration diagram of the wireless communication system 1 according to the first embodiment shown in FIG. 1.

### [Configuration of Non-Reproduction Wireless Relay Device]

The functional configuration of the non-reproduction wireless relay device 10 will be described below.

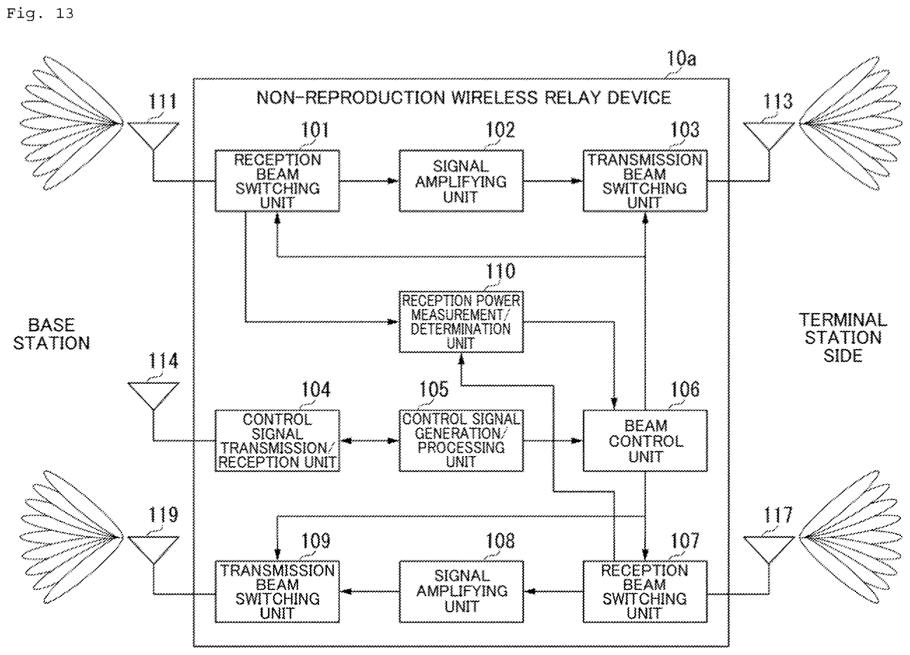

FIG. 13 is a block diagram illustrating the configuration of a non-reproduction wireless relay device 10a according to fifth embodiment. The non-reproduction wireless relay device 10a is a relay device for relaying a signal by non-reproduction wireless relay or the like. Therefore, as shown in FIG. 13, the non-reproduction wireless relay device 10a does not have the digital processing circuit for performing the digital processing on the signal to be relayed. The digital processing here includes the signal processing such as demodulation, modulation, error correction, and the like, and generation of the beam search signal.

As shown in FIG. 13, the non-reproduction wireless relay device 10a includes the reception beam switching unit 101, the signal amplifying unit 102, the transmission beam switching unit 103, the control signal transmission/reception unit 104, the control signal generation/processing unit 105, the beam control unit 106, the reception beam switching unit 107, the signal amplifying unit 108, the transmission beam switching unit 109, a reception power measurement/determination unit 110, the base station side reception antenna 111, the terminal station side transmission antenna 113, the control signal transmission/reception antenna 114, the terminal station side reception antenna 117 and the base station side transmission antenna 119.

The non-reproduction wireless relay device 10a according to the fifth embodiment shown in FIG. 13 is different from the configuration of the non-reproduction wireless relay device 10 according to the first embodiment shown in FIG. 2 in that the non-reproduction wireless relay device 10a further includes the reception power measurement/determination unit 110.

A reception power measurement/determination unit 110 measures reception power when a reception beam switching unit 101 on the base station side receives a signal, and reception power when a reception beam switching unit 107 on the terminal station side receives a signal. The non-reproduction wireless relay device 10a according to the fifth embodiment can specify the beam ID of the reception beam where the reception power becomes maximum by providing the reception power measurement/determination unit 110.

The block diagram illustrating the functional configuration of the base station according to the fifth embodiment is the same as the block diagram illustrating the functional configuration of the base station 20 according to the first embodiment shown in FIG. 3.

In order to make the explanation easier to understand, a wireless communication system, each device, and each function unit according to the fifth embodiment have the same reference numerals as those corresponding to the wireless communication system, the respective devices, and the respective function units according to the first embodiment and will be described.

### [Operation of Base Station]

The following describes an example of the operation of the base station 20.

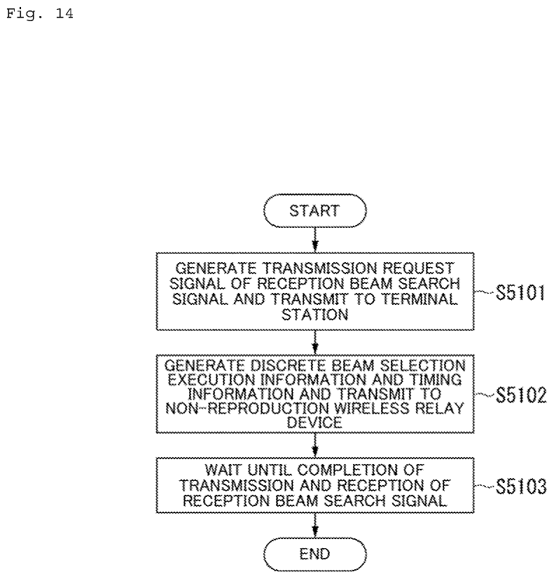

FIG. 14 is a flowchart illustrating the operation of the base station 20 according to the fifth embodiment. The operation of the base station 20 illustrated in the flowchart of FIG. 14 is started when the base station 20 executes the discrete beam selection of the reception beam to the terminal station 30 side of the non-reproduction wireless relay device 10a.

The control signal generation unit 204 of the base station 20 generates the transmission request signal of the reception beam search signal to be transmitted to the terminal station 30. The transmission request signal of the reception beam search signal, mentioned here, a signal for requesting the terminal station 30 to transmit the beam search signal (the reception beam search signal) to the non-reproduction wireless relay device 10a. The control signal generation unit 204 outputs the transmission request signal of the generated reception beam search signal to the transmission beam switching unit 202.

The transmission beam switching unit 202 of the base station 20 acquires the transmission request signal of the reception beam search signal outputted from the control signal generation unit 204. The transmission beam switching unit 202 transmits the transmission request signal of the acquired reception beam search signal to the terminal station 30 by the transmission antenna 212 (via a non-reproduction wireless relay device 10a) (step S5101).

The control signal generation/processing unit 208 generates discrete beam selection execution information indicating that discrete beam selection of the reception beam to the terminal station 30 side of the non-reproduction wireless relay device 10a is performed. The control signal generation/processing unit 208 generates timing information indicating arrival timing when the reception beam search signal used in the discrete beam search selection arrives from the terminal station 30 to the non-reproduction wireless relay device 10a. The control signal generation/processing unit 208 outputs the generated discrete beam selection execution information and timing information to the control signal transmission/reception unit 209.

The control signal transmission/reception unit 209 acquires the discrete beam selection execution information and the timing information outputted from the control signal generation/processing unit 208. The control signal transmission/reception unit 209 transmits the acquired discrete beam selection execution information and the timing information to the non-reproduction wireless relay device 10a by the control signal transmission/reception antenna 219 (step S5102).

Next, the base station 20 waits until the transmission and reception of the reception beam search signal transmitted from the terminal station 30 is completed on the basis of the transmitted timing information (waits until the transmission and reception of the relay device is completed) (step S5103). This completes the operations of the base station 20 illustrated in the flowchart of FIG. 14.

### [Operation of Non-Reproduction Wireless Relay Device]

An example of the operation of the non-reproduction wireless relay device 10a will be described below.

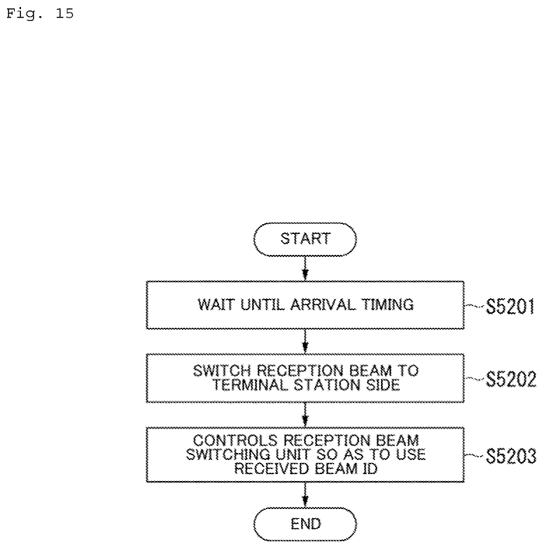

FIG. 15 is a flowchart illustrating the operation of the non-reproduction wireless relay device 10a according to the fifth embodiment. The operation of the non-reproduction wireless relay device 10a illustrated by the flowchart of FIG. 15 is started when the control signal transmission/reception unit 104 of the non-reproduction wireless relay device 10a receives the discrete beam selection execution information and the timing information transmitted from the base station 20 by the control signal transmission/reception antenna 114 in the step S5102 of the flowchart illustrated in FIG. 14.

The non-reproduction wireless relay device 10a waits until the arrival timing of the reception beam search signal based on the timing information received by the control signal transmission/reception unit 104 comes (step S5201). When the arrival timing comes, the beam control unit 106 controls the reception beam switching unit 107 to switch the formation direction of the reception beam formed by the terminal station side reception antenna 117, and the reception power measurement/determination unit 110 measures reception power (step S3202).

Thus, the non-reproduction wireless relay device 10a can switch the forming direction of the reception beam on the side of the terminal station 30 during the transmission period of the reception beam search signal transmitted from the terminal station.

Further, the number of generations of the reception beam search signal can be defined by the transmission request signal of the reception beam search signal transmitted from the base station 20. Thus, the base station 20 collects the information indicating the number of reception beams (the candidate beams) to the terminal station 30 side of the non-reproduction wireless relay device 10a in advance from the non-reproduction wireless relay device 10a, and thereby can generate reception beam search signals for the number of reception beams (the candidate beams) to the terminal station 30 side of the non-reproduction wireless relay device 10a.

Thus, in the wireless communication system 1 according to the fifth embodiment, the wireless communication system 1 can use the reception beam search signal for the discrete beam selection of the reception beam to the terminal station 30 side of the non-reproduction wireless relay device 10 by measuring the reception power for the base station (the terminal station may not recognize the presence of the relay device) while switching the formation direction of the reception beam.

The reception power measurement/determination unit 110 of the non-reproduction wireless relay device 10a measures the reception power of the reception beam search signal for each reception beam as described above. The reception power measurement/determination unit 110 selects the beam ID of the reception beam having the largest reception power on the basis of the measurement result. The reception power measurement/determination unit 110 outputs the information indicating the selected beam ID to the beam control unit 106.

The beam control unit 26 acquires the information indicating the received beam ID outputted from the reception power measurement/determination unit 110. The beam control unit 26 controls the reception beam switching unit 107 so that a signal of wireless communication is relayed by using the reception beam corresponding to the beam ID based on the acquired information (step S5203).

This completes the operation of the non-reproduction wireless relay device 10a shown in the flowchart of FIG. 15.

With the above-described configuration, the wireless communication system 1 according to the fifth embodiment can control the switching of the reception beam to the terminal station side in the relay device by the different signal (the control signal) from the signal relayed by the relay device. Thus, in the wireless communication system 1 according to the fifth embodiment, even if the relay device does not have the digital processing circuit for performing the digital processing on the signal to be relayed, the discrete beam selection of the reception beam to the terminal station side in the relay device can be performed.

### Sixth Embodiment

The sixth embodiment of the present invention will be described below.

The wireless communication system 1 according to the fifth embodiment is configured to perform the discrete beam selection of the transmission beam to the terminal station side of the non-reproduction wireless relay device 10a. On the other hand, the wireless communication system according to the sixth embodiment described below is a communication system capable of performing the discrete beam selection of the reception beam to the base station side of the non-reproduction wireless relay device.

The entire configuration diagram of the wireless communication system according to the sixth embodiment is the same as the entire configuration diagram of the wireless communication system 1 according to the first embodiment shown in FIG. 1. The block diagram illustrating the functional configuration of the non-reproduction wireless relay device according to the sixth embodiment is the same as the block diagram illustrating the functional configuration of the non-reproduction wireless relay device 10a according to the fifth embodiment shown in FIG. 13. The block diagram illustrating the functional configuration of the base station according to the sixth embodiment is the same as the block diagram illustrating the functional configuration of the base station 20 according to the first embodiment shown in FIG. 3.

In order to make the explanation easier to understand, a wireless communication system, each device, and each function unit according to the sixth embodiment have the same reference numerals as those corresponding to the wireless communication system, the respective devices according to the first embodiment, and the respective function units according to the fifth embodiment and will be described.

### [Operation of Base Station]

The following describes an example of the operation of the base station 20.

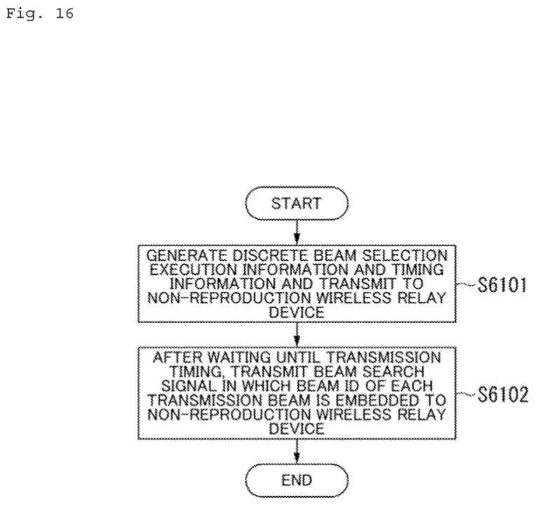

FIG. 16 is a flowchart illustrating the operation of the base station 20 according to the sixth embodiment. The operation of the base station 20 shown in the flowchart of FIG. 16 is started when the base station 20 executes the discrete beam selection of the reception beam to the base station 20 side of the non-reproduction wireless relay device 10a.

The control signal generation/processing unit 208 of the base station 20 generates discrete beam selection execution information indicating that discrete beam selection of the reception beam to the base station 20 side of the non-reproduction wireless relay device 10a is performed, and timing information indicating transmission timing of the beam search signal used in the discrete beam search selection. The control signal generation/processing unit 208 outputs the generated discrete beam selection execution information and timing information to the control signal transmission/reception unit 209.

The control signal transmission/reception unit 209 of the base station 20 acquires the discrete beam selection execution information and timing information outputted from the control signal generation/processing unit 208. The control signal transmission/reception unit 209 transmits the acquired discrete beam selection execution information and timing information to the non-reproduction wireless relay device 10a by the control signal transmission/reception antenna 219 (step S6101).

Next, the base station 20 waits until the transmission timing based on the timing information transmitted to the non-reproduction wireless relay device 10a comes. When the transmission timing comes, the beam search signal generation unit 203 of the base station 20 generates the beam search signal in which the beam ID of each reception beam (each candidate beam) of the base station 20 side of the non-reproduction wireless relay device 10a is embedded. The beam search signal generation unit 203 outputs the generated beam search signal to the transmission beam switching unit 202.

The transmission beam switching unit 202 acquires the beam search signal outputted from the beam search signal generation unit 203. The transmission beam switching unit 202 transmits the beam search signal to the non-reproduction wireless relay device 10a by the transmission antenna 212 (step S6102). This completes the operations of the base station 20 shown in the flowchart of FIG. 16.

### [Operation of Non-Reproduction Wireless Relay Device]

An example of the operation of the non-reproduction wireless relay device 10a will be described below.

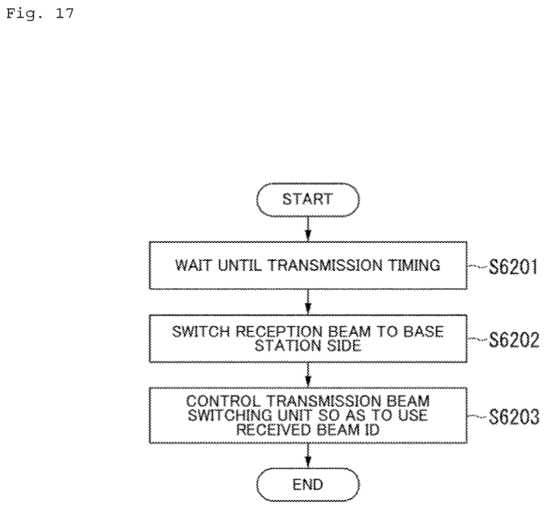

FIG. 17 is a flowchart illustrating the operation of the non-reproduction wireless relay device 10a according to the sixth embodiment. The operation of the non-reproduction wireless relay device 10a shown by the flowchart of FIG. 17 is started when the control signal transmission/reception unit 104 of the non-reproduction wireless relay device 10a receives the discrete beam selection execution information and timing information transmitted from the base station 20 by the control signal transmission/reception antenna 114 in the step S6101 of the flowchart illustrated in FIG. 16.

The non-reproduction wireless relay device 10a waits until transmission timing based on the timing information received by the control signal transmission/reception unit 104 comes (step S6201). When the transmission timing comes, the beam control unit 106 controls the reception beam switching unit 101 to switch the formation direction of the reception beam formed by the base station side reception antenna 111, and the reception power measurement/determination unit 110 measures the reception power (step S6202).

Thus, the non-reproduction wireless relay device 10a can switch the forming direction of the reception beam on the base station 20 side during the transmission period of the beam search signal transmitted from the base station.

Further, the number of generations of the reception beam search signals can be defined by the transmission request signal of the reception beam search signal transmitted from the base station 20. Thus, the base station 20 collects the information indicating the number of the reception beam (the candidate beam) to the base station 20 side of the non-reproduction wireless relay device 10a in advance from the non-reproduction wireless relay device 10a, and thereby can generate reception beam search signals for the number of the reception beam (the candidate beam) to the base station 20 side of the non-reproduction wireless relay device 10a.

The reception power measurement/determination unit 110 of the non-reproduction wireless relay device 10a measures the reception power of the reception beam search signal for each reception beam as described above. The reception power measurement/determination unit 110 selects the beam ID of the reception beam having the largest reception power on the basis of the measurement result. The reception power measurement/determination unit 110 outputs the information indicating the selected beam ID to the beam control unit 106.

The beam control unit 106 acquires the information indicating the received beam ID outputted from the reception power measurement/determination unit 110. The beam control unit 26 controls the reception beam switching unit 101 so that a signal of wireless communication is relayed by using the transmission beam corresponding to the beam ID based on the acquired information (step S6203).

This completes the operation of the non-reproduction wireless relay device 10a shown in the flowchart of FIG. 17.

With the above-described configuration, the wireless communication system 1 according to the sixth embodiment can control the switching of the reception beam to the base station side in the relay device by the different signal (the control signal) from the signal relayed by the relay device. Thus, in the wireless communication system 1 according to the sixth embodiment, even if the relay device does not have the digital processing circuit for performing the digital processing on the signal to be relayed, the discrete beam selection of the reception beam to the base station side in the relay device can be performed.

As described above, according to the wireless communication system 1 in each embodiment of the present invention, even in the non-reproduction wireless relay device not including the digital processing circuit for performing digital processing on the signal to be relayed, since the base station and the non-reproduction wireless relay device are provided with function units for transmitting and receiving the wireless signal different from the main signal, the beam of the non-reproduction wireless relay device can be controlled by the base station. Then, the wireless communication system 1 can perform the discrete beam selection for specifying the optimum beam from among candidate beams by switching the candidate beams in the non-reproduction wireless relay device in accordance with the timing of the beam search signal (or the reception beam search signal) generated by the digital processing circuits provided in the base station and the terminal station.

In addition, according to the wireless communication system 1 in each embodiment of the present invention, the occurrence of processing delay can be prevented, since the demodulation, the modulation, and the error correction are not performed by the relay device. Further, according to the wireless communication system 1 in each embodiment of the present invention, since the number of circuits can be reduced without requiring the digital processing circuit in the relay device, the relay device can be miniaturized, and the device cost can be reduced.

In the above embodiments, the base station 20 is provided with the control signal generation/processing unit 208, but the present invention is not limited to this. For example, the external device connected to a higher-level network may include the control signal generation/processing unit 208.

In each of the above embodiments, the base station 20 transmits the beam search signal to the non-reproduction wireless relay devices 10 (10a), and the base station 20 and the non-reproduction wireless relay devices 10 (10a) perform the processing in accordance with the timing. However, the present invention is not limited to this configuration, but other configurations may be used if the timing of the transmission (or the arrival of the reception beam search signal) of the beam search signal can be matched with the timing of switching the candidate beam in the non-reproduction wireless relay device 10.

For example, it may be configured to notify the base station 20 by the control signal each time when the non-reproduction wireless relay devices 10 (10a) switches the candidate beam, and transmit the beam search signal to the non-reproduction wireless relay devices 10 (10a) each time when the base station 20 receives the notification. Also, for example, it may be configured to notify the terminal station 30 by the control signal every time when the non-reproduction wireless relay devices 10 (10a) switches the candidate beam, and transmit the reception beam search signal to the non-reproduction wireless relay devices 10 (10a) every time when the terminal station 30 receives the notification.

In each of the above embodiments, the non-reproduction wireless relay devices 10 (10a) is configured to switch to all of the candidate beams, but the present invention is not limited thereto. For example, when the approximate appropriate beam direction can be estimated in advance, it is possible to switch only a unit of candidate beams such as switching to only candidate beams in the estimated beam direction and the beam direction around the estimated beam direction. In this case, for example, the processing time required for the discrete beam selection can be shortened.

As a method for estimating the approximate appropriate beam direction in advance, for example, there are several methods such as a method for estimating the beam direction from the beam direction of the beam used in communication with the immediately preceding wireless station, a method for estimating the beam direction based on the position of each wireless station and the non-reproduction wireless relay device specified by the positioning system such as GPS (Global Positioning System) or the like provided in each wireless station and the non-reproduction wireless relay device, a method for estimating the beam direction on the basis of a selection result in discrete beam selection performed by another wireless device provided in each wireless station and the non-reproduction wireless relay device, and a method for estimating the beam direction on the basis of the direction of the wireless station to be communicated specified by image recognition from an image captured from the position of the certain wireless station.

The wireless communication using the high frequency band such as the millimeter wave band has a feature that the free space propagation loss is larger than that of the wireless communication using the low frequency band such as the microwave band. In order to compensate for this free space propagation loss, it may be desirable to perform the discrete beam selection not only in the non-reproduction wireless relay device but also in the base station and the terminal station. The present invention is also applicable to such a case where the discrete beam selection is performed in such the base station and the terminal station.

According to the above embodiment, the wireless communication device includes a reception unit, a transmission unit, a control signal transmission/reception unit, and a beam control unit. For example, the wireless communication device is the non-reproduction wireless relay devices 10 (10a) in the embodiment, the reception unit is the base station side reception antenna 111 and the terminal station side reception antenna 117 in the embodiment, the transmission unit is the terminal station side transmission antenna 113 and the base station side transmission antenna 119 in the embodiment, the control signal transmission/reception unit is the control signal transmission/reception unit 104 in the embodiment, and the beam control unit is the beam control unit 106 in the embodiment.

According to the embodiment described above, the reception unit receives a signal transmitted from a first wireless station, and the transmission unit transmits the signal received by the reception unit to a second wireless station. For example, the first wireless station is the base station 20 in the embodiment, and the second wireless station is the terminal station 30 in the embodiment, the signal is transmitted and received between the base station 20 and the terminal station 30 in the embodiment, and is a signal of wireless communication in which the non-reproduction wireless relay devices 10 (10a) relays.

According to the above embodiment, the control signal transmission/reception unit transmits/receives a control signal related to switching of a reception beam used in the reception unit or a transmission beam used in the transmission unit to/from the external equipment, and the beam control unit controls switching of the reception beam or the transmission beam on the basis of the control signal. For example, the external equipment is the base station 20 and the terminal station 30 in the embodiment, and the control signal is a signal including the discrete beam selection execution information, timing information indicating transmission timing or arrival timing of the beam search signal, the transmission request signal of the reception beam search signal, and the like.

The external equipment may be the first wireless station or the second wireless station. Alternatively, the external equipment may be an equipment connected to an upper-level network which is communicatively connected via the first wireless station or the second wireless station.

The wireless communication device may further include a reception power measurement unit for measuring the reception power in the reception of the signal by the reception unit. In this case, the beam control unit may control switching of the reception beam or the transmission beam on the basis of the reception power measured by the reception power measurement unit. For example, the reception power measurement unit is the reception power measurement/determination unit 110 in the embodiment.

The control signal received by the control signal transmission/reception unit may include the information for identifying the candidate beam used in the discrete beam selection of the reception beam or the transmission beam. For example, the control signal in this case is the information indicating the beam ID of the beam used in the embodiment, the beam ID feedback signal, and the like, the information identifying the candidate beam is the beam ID in the embodiment, and the discrete beam selection is performed for selecting the transmission beam on the terminal station side, the transmission beam on the base station side, and the reception beam on the terminal station side and the reception beam on the base station side.

The control signal received by the control signal transmission/reception unit may include the information indicating the timing of switching the candidate beam used in the discrete beam selection of the reception beam or the transmission beam. For example, the control signal in this case is a signal including timing information in the embodiment.

The control signal transmitted to the external equipment by the control signal transmission/reception unit may include the information for identifying the candidate beam having the best signal reception quality among candidate beams used in the discrete beam selection of the reception beam or the transmission beam. For example, the control signal in this case is a beam ID feedback signal in the embodiment.

Some or all of the configuration of the non-reproduction wireless relay devices 10 (10a), the base station 20 and the terminal station 30 in the above-described embodiment may also be realized by a computer. In this case, the function may be realized by recording a program used to realize the function on a computer-readable recording medium and causing the computer system to load and execute the program recorded on the recording medium. Note that the “computer system” mentioned here includes an OS and hardware such as peripheral equipment. Further, the “computer-readable recording medium” represents a transportable medium such as a flexible disk, a magneto-optical disk, a ROM, and a CD-ROM and a storage device such as a hard disk embedded in the computer system. In addition, the “computer-readable recording medium” may also include a recording medium that dynamically retains a program for a short period of time like a communication line used to transmit the program via a network such as the Internet or a communication line such as a telephone line and a recording medium that retains a program for a certain period of time like a server or a volatile memory inside the computer system that serves as a client in that case. Moreover, the program described above may be any of a program for realizing a unit of the functions described above, a program capable of realizing the functions described above in combination with a program already recorded in a computer system, and a program for realizing the functions using a programmable logic device such as an FPGA (Field Programmable Gate Array).

Although the embodiments of the present invention have been described in detail with reference to the drawings, specific configurations are not limited to these embodiments, and designs and the like within a range that does not deviating from the gist of the present invention are also included.

### REFERENCE SIGNS LIST

1 Wireless communication system

10, 10a Non-reproduction wireless relay device

20 Base station

26 Beam control unit

30 Terminal station

91 Wireless station

92 Wireless station

101 Reception beam switching unit

102 Signal amplifying unit

103 Transmission beam switching unit

104 Control signal transmission/reception unit

105 Control signal generation/processing unit

106 Beam control unit

107 Reception beam switching unit

108 Signal amplifying unit

109 Transmission beam switching unit

110 Reception power measurement/determination unit

111 Base station side reception antenna

113 Terminal station side transmission antenna

114 Control signal transmission/reception antenna

117 Terminal station side reception antenna

119 Base station side transmission antenna

201 Data processing unit

202 Transmission beam switching unit

203 Beam search signal generation unit

204 Control signal generation unit

205 Beam ID read out unit

206 Data processing unit

207 Reception beam switching unit

208 Control signal generation/processing unit

209 Control signal transmission/reception unit

212 Transmission antenna

217 Reception antenna

219 Control signal transmission/reception antenna

1. A wireless communication method comprising:
a reception step of receiving a signal transmitted from a first wireless station;
a transmission step of transmitting the signal received in the reception step to a second wireless station;
a control signal transmission/reception step of transmitting/receiving a control signal related to switching of a reception beam used in the reception step or a transmission beam used in the transmission step to/from external equipment; and
a beam control step of controlling switching of the reception beam or the transmission beam based on the control signal.

2. The wireless communication method according to claim 1, wherein
an external equipment is the first wireless station or the second wireless station.

3. The wireless communication method according to claim 1, wherein
the external equipment is an equipment connected to an upper-level network which is communicatively connected via the first wireless station or the second wireless station.

4. The wireless communication method according to claim 1 further comprising
A reception power measurement step of measuring a reception power in the reception of the signal in the reception step, wherein
the beam control step controls the switching of the reception beam or the transmission beam on the basis of the reception power measured in the reception power measurement step.

5. The wireless communication method according to claim 1, wherein
a control signal received by the control signal transmission/reception step includes the information for identifying a candidate beam used in discrete beam selection of the reception beam or the transmission beam.

6. The wireless communication method according to claim 1, wherein
the control signal received by the control signal transmission/reception step includes the information indicating a timing of switching the candidate beam used in the discrete beam selection of the reception beam or the transmission beam.

7. The wireless communication method according to claim 1, wherein
the control signal transmitted to the external equipment in the control signal transmission/reception step includes the information for identifying the candidate beam whose reception quality of the signal is the best among candidate beams used for performing the discrete beam selection of the reception beam or the transmission beam.

8. A wireless communication device comprising:
a reception unit configured to receive the signal transmitted from the first wireless station;
a transmission unit configured to transmit the signal received by the reception unit to the second wireless station;
a control signal transmitting/receiving unit configured to transmit/receive the control signal related to the switching between the reception beam used in the reception unit or the transmission beam used in the transmission unit; and
a beam control unit configured to control the switching of the reception beam or the transmission beam on the basis of the control signal.
